(19) United States
(12) Patent Application Publication
(10) Pub. No.: US 2004/0216531 A1
(43) Pub. Date: Nov. 4, 2004

(54) Device for determining the position of a tool and/or a machine component of a machine tool or production machine

(75) Inventors: Wolfgang Papiernik, Neunkirchen (DE); Martin Schroder, Herzogenaurach (DE); Guido Stoppler, Nurnberg (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/811,073

(22) Filed: Mar. 26, 2004

(30) Foreign Application Priority Data
Mar. 27, 2003 (DE) 103 13 895.1

(51) Int. Cl. G01N 3/20

(52) U.S. Cl. 73/849

(57) ABSTRACT

A device for determining the position of a tool and/or a load-bearing machine component of a machine tool or production machine includes a primary crossbeam arranged between two movable support elements and supporting the tool or the machine component, and a rigid secondary crossbeam which is also supported between the support elements. A contactless measuring unit is connected with the crossbeam and constructed to measure a deflection of the primary crossbeam relative to the secondary crossbeam. The deflection is hereby commensurate with a position of the tool and/or a load-bearing machine component and may depend on the acceleration force, weight and/or processing force exerted on the tool or the machine component.

### CROSS-REFERENCES TO RELATED APPLICATIONS

This application claims the priority of German Patent Application, Serial No. 103 13 895.1, filed Mar. 27, 2003, pursuant to 35 U.S.C. 119(a)-(d), the disclosure of which is incorporated herein by reference.

### BACKGROUND OF THE INVENTION

The present invention relates to a device for determining the position of a tool and/or a load-support machine component of a machine tool or production machine, wherein the tool or the machine component is arranged on a crossbeam between two movable supports.

Two-dimensional positioning machines frequently include gantry drives, whereby force is transmitted via the two ends of a crossbeam. A long crossbeam that is fabricated of a material with relatively poor damping characteristic, such as steel or aluminum, can experience a relatively large deflection and low-frequency oscillations with a relatively large amplitude. The deflection causes a dynamic contour variation at the tool center point (TCP). If the deflection can be measured dynamically, an additional drive can then be installed at the TCP to compensate for the corresponding deviation. Such approach is known, for example, from German Pat. No. DE 101 56 781 C1. Even without such additional drive or if the gantry drives are not controlled, it may still be advantageous to continuously and accurately measure the resulting deflection for quality assurance studies.

The deflection and oscillation characteristic can be determined particularly during the setup phase using precise, complex measuring devices. However, high costs render a permanent installation of such measuring devices on the machine economically impractical. Although a relatively accurate measuring unit could conceivably be provided on or in the machine in the vicinity of the TCP, which continuously measures distances outside the machine relative to stationary reference points, however, the distance to be measured is typically quite large and the achievable resolution is low. In addition, a measurement beam, for example an optical beam, could also be adversely affected by external disturbances.

It would therefore be desirable and advantageous to provide a method and a device for determining the deflection of the crossbeam which obviates prior art shortcomings and specifically is technically simple to implement and highly precise.

### SUMMARY OF THE INVENTION

According to one aspect of the present invention, a device for determining the position of a tool and/or a load-bearing machine component of a machine tool or production machine includes a primary crossbeam disposed between two movable support elements and supporting the tool or the machine component, a rigid secondary crossbeam supported between the support elements, and a contactless measuring unit connected with the primary crossbeam and constructed to measure a deflection of the primary crossbeam relative to the secondary crossbeam. The deflection is hereby commensurate with the position of the tool and/or a load-bearing machine component and may depend on the acceleration force, the weight, and/or the processing force exerted on the tool or the machine component.

According to another advantageous feature of the present invention, the secondary crossbeam may be arranged in close proximity of the primary crossbeam and may face the actual crossbeam.

According to another advantageous feature of the present invention, the secondary crossbeam can have a stiffness perpendicular to a travel direction of the tool or the machine component that is greater than the stiffness of the primary crossbeam.

According to another advantageous feature of the present invention, the secondary crossbeam can be made of a carbon composite. In this way, the secondary crossbeam is lightweight while still exhibiting sufficient stiffness in the travel direction.

According to another advantageous feature of the present invention, the measuring unit may be arranged in close proximity to the tool or the machine component, so that the deflection can be measured even if the TCP is placed at different positions along the primary crossbeam.

According to another advantageous feature of the present invention, the measuring unit may be constructed as a measuring instrument using laser triangulation. This measurement method is very cost-effective and highly precise. As an alternative, the secondary crossbeam can include a metallic surface, with the measuring unit being constructed for inductive or capacitive measurement. Although a measuring unit of this type is slightly less accurate than a laser-based measuring instrument, it tends to be significantly less expensive.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a basic schematic illustration, in perspective view, of a primary crossbeam with a machine component and an secondary crossbeam resting on two supports; and

FIG. 2 is a schematic diagram depicting the mathematical relationships used to determine the deflection of the primary crossbeam.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

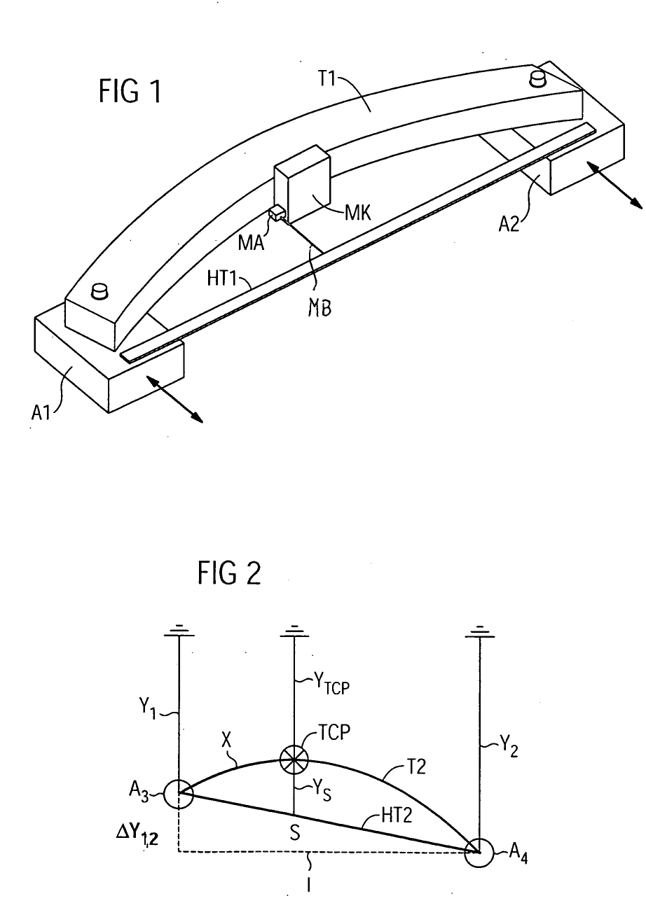

Turning now to the drawing, and in particular to FIG. 1, there is shown by way of a basic representation a first support A1 and a second support A2 that can move on support elements in two travel directions indicated by double arrows. The support elements are not shown for sake of clarity of the drawing. A primary crossbeam T1 is arranged between the support A1 and the support A2, with a machine component MK attached to the primary crossbeam T1. The machine component can be, for example, a tool holder and a similar component. A measuring unit MA is located directly on the machine component MK. The measuring unit MA emits a contactless measurement beam MB, e.g. a laser beam, oriented parallel to the axis of the travel direction. The measurement beam MB measures the distance to a secondary crossbeam HT1, without contacting the crossbeam HT1. The secondary crossbeam HT1 is like the primary crossbeam T1 flexibly arranged on the supports A1 and A2, respectively. The secondary crossbeam HT1 can be, for example, a ruler made of a carbon composite material which has a high stiffness in the travel direction and which, unlike the primary crossbeam T1, is hence not deflected by the travel motion or the load of the machine component MK. It should be noted that the deflection of the primary crossbeam T1 in FIGS. 1 and 2 is exaggerated to illustrate the effect.

FIG. 2 shows the mathematical relationship between the actual deflection of the primary crossbeam and the quantities measured by the measuring unit MA. The supports A3 and A4, which essentially correspond to the supports A1 and A2 of FIG. 1, are shown as circles. A primary crossbeam T2 is located between the supports A3 and A4, schematically shown as an arc, as well as an secondary crossbeam HT2 that is also supported by the supports A3 and A4. The supports A3 and A4 are indicated as having position coordinates Y₁ and Y₂ relative to a reference location, indicated by horizontally hatched triangles. The reference locations can be measured by transducers located on the drives (not shown in FIG. 2). If the distance X between the tool center point TCP and the support A3 and the distance I (indicated by the dotted line) between the travel axes are known, then the deflection Y_{S} can be determined by a simple measurement of the distance between the tool center point TCP and the secondary crossbeam HT2 (i.e., a point S on the secondary crossbeam HT2) in the direction of the travel axes. The computation can be simplified by assuming that the chord length, i.e. the length of the secondary crossbeam HT2, is equal to the arc length of the primary crossbeam T2, i.e., the length of the primary crossbeam T2, remains unchanged under deflection. This simplification is a good approximation if the deflection is small relative to the distance between the travel axes. The position of the tool center point TCP in the Y-direction can then be determined by measuring the distance between the tool center point TCP and the point S. The following relationship governs:

$${Y}_{TCP} = \frac{X}{l} \cdot abs ( {Y}_{1} - {Y}_{2} ) + min ( {Y}_{1} ; {Y}_{2} ) - {Y}_{S}$$

As mentioned above, the secondary crossbeam HT1 (of FIG. 1) or HT2 (of FIG. 2) should be very rigid or stiff in the direction perpendicular to the travel direction. This can be achieved by using a material with a high stiffness in relation to its weight, such as, for example, a composite material that includes carbon fibers. Alternatively, the required stiffness can also be obtained with a suitable geometry of the secondary crossbeam. The flexural strength is proportional to the second order geometrical moment of inertia I₀, which for a rectangular profile with a height h and a width b is (in the direction of the width) I₀=h·b²/12. The reference (or secondary) crossbeam should accordingly have the smallest possible height and the greatest possible width. The alignment tolerances of the reference crossbeam can be relaxed by performing, before the machine is operated, a reference travel run in the X-direction without excitation in the Y-direction. The achievable accuracy depends essentially on the following factors:

Position accuracy of the supports,

Oscillations between the transducers and the supports of the secondary crossbeam,

Length changes of the elastic crossbeam,

Position accuracy of the supports of the reference crossbeam, and

Accuracy of the sensor mounted on the primary crossbeam, which measures the distance between the tool, for example cutting head, and the reference crossbeam.

It will be understood by persons skilled in the art that the principles described in the description are generally applicable to machines having more than one tool or to other load-bearing machine elements.

During the course of a reference travel run, it is, of course, also possible to initially determine static errors of the reference crossbeam and to store them in a table for subsequent compensation.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A device for determining the position of a tool and/or a load-bearing machine component of a machine tool or production machine, comprising:
a primary crossbeam disposed between two movable support elements and supporting the tool or the machine component,
a rigid secondary crossbeam supported between the support elements; and
a contactless measuring unit connected with the primary crossbeam and constructed to measure a deflection of the primary crossbeam relative to the secondary crossbeam.

2. The device of claim 1, wherein the deflection is dependent on at least one of an acceleration force, a weight and a processing force exerted on the tool or the machine component.

3. The device of claim 1, wherein the secondary crossbeam has a stiffness perpendicular to a travel direction of the tool or the machine component that is greater than a stiffness of the primary crossbeam.

4. The device of claim 1, wherein the secondary crossbeam is made of a carbon composite.

5. The device of claim 1, wherein the measuring unit is arranged in close proximity to the tool or the machine component.

6. The device of claim 1, wherein the measuring unit is constructed as a measuring instrument using laser triangulation.

7. The device 1, wherein the measuring unit emits a laser beam for measuring a distance between the primary and secondary crossbeams.

8. The device of claim 1, wherein the secondary crossbeam includes a metallic surface, with the measuring unit being constructed for inductive or capacitive measurement.
